(19) United States
(12) Patent Application Publication
(10) Pub. No.: US 2020/0371323 A1
(43) Pub. Date: Nov. 26, 2020

(54) Camera and Lens Systems Using Off-Axis Free Form Elements and Methods Therefor

(71) Applicant: DynaOptics Ldt, Singapore (SG)

(72) Inventors: Jyh Long Chern, Chubei City (TW); Vadim VLAKHKO, Moscow (RU); Fedor CHURLIAEV, Moscow (RU); Li Han CHAN, Oakland, CA (US)

(21) Appl. No.: 16/688,955

(22) Filed: Nov. 19, 2019

Related U.S. Application Data
(63) Continuation-in-part of application No. 15/958,804, filed on Apr. 20, 2018.
Application No. 15/958,804 is a continuation-in-part of application No. PCT/IB2016/001630, filed on Oct. 20, 2016.
Application No. PCT/IB2016/001630 is a continuation-in-part of application No. PCT/US19/57467, filed on Oct. 22, 2019.
(60) Provisional application No. 62/769,519, filed on Nov. 19, 2018.
(60) Provisional application No. 62/244,171, filed on Oct. 20, 2015.
(60) Provisional application No. 62/748,961, filed on Oct. 22, 2018.
(60) Provisional application No. 62/748,976, filed on Oct. 22, 2018.

(51) Int. Cl. G02B 15/14; G02B 27/00; H04N 5/225; G02B 3/00

(52) U.S. Cl. CPC G02B 15/14; G02B 3/0006; H04N 5/2254; G02B 27/0012

(57) ABSTRACT

Multi-camera optical systems comprising a center camera together with left and right side cameras. The left and right side cameras comprise free form lenses to provide off-axis imaging, where the resulting multiple images permit wide angle, normal, and zoom views of an object space. The center camera can also comprise free form optics such as a double symmetry lens, and overall the free form optics enable low f-number, wide field of view, improved off-axis performance, and other optical characteristics not achievable with rotationally symmetric lenses. The design can be implemented using existing manufacturing techniques.

### RELATED APPLICATIONS

This application is conversion of U.S. Patent Application Ser. No. 62/769,519 filed Nov. 19, 2018, and further is a continuation-in-part of U.S. patent application Ser. No. 15/958,804 filed on Apr. 20, 2018, entitled Low Distortion Lens Using Double Plane Symmetric Element, which is turn is a continuation-in-part of PCT Application PCT/IB2016/001630 having International Filing Date 20 Oct. 2016, which in turn claims the benefit of U.S. Patent Application 62/244,171, filed 20 Oct. 2015. The present application claims the benefit of priority of each of the foregoing applications, all of which are incorporated herein for all purposes. The present application also claims the benefit of PCT Application PCT/US2019/057467 filed 22 Oct. 2019 which in turn is a conversion of U.S. Patent Application Ser. No. 62/748,976, filed on 22 Oct. 2018, entitled Low Light Optical System Utilizing Double Plane Symmetry Defined by X-Y Polynomial, as well as U.S. Patent Application Ser. No. 62/748,961 entitled Lens Systems Using Free Form Elements to Match Object Space and Image Space, and Methods Therefor and also filed on 22 Oct. 2018. The present application claims the benefit of priority of each of the foregoing applications, all of which are incorporated herein for all purposes.

### FIELD OF THE INVENTION

This invention relates generally to lens systems using free form lenses, and more particularly relates to lens systems configured to provide, selectively, an image space ranging from a relatively wide field of view to a substantially smaller field of view, thus effectively providing a zoom lens system.

### BACKGROUND OF THE INVENTION

The general task of an optical design is to make a perfect conjugation between the object space or plane and the image space or sensor plane, with no aberrations, distortions or other errors. Although many lenses are very good, such perfection is elusive. Even small increments can provide significant benefit. The issue becomes more problematic when the lens system is intended to provide multiple focal lengths, such as with a zoom lens system. When the design is intended to fit into a small form factor, such as a lens module and associated sensors for use as a camera in a smartphone or similar volume-limited application, the challenges become dramatically more acute.

Rotational symmetry is widely used in conventional lenses, with the field of view and the aperture stop both being rotationally symmetric. With only rare exception, this results in the final design comprising rotationally symmetric elements. However, most sensors—the photosensitive structures that record the image—are rectangular in shape. Thus, the image space created by a rotationally symmetric lens system creates a circular field of view, while the sensor that records the image is a rectangle. In an effort to optimize the mismatch, the diameter of the field of view of the lens system is matched to the diagonal size of the sensor.

One of the major shortcomings of current lens systems for smartphones is the lack of optical zoom. Volume, footprint, and z-height limitations in smartphones make it difficult, if not impossible, to achieve optical zoom using conventional rotationally symmetric lens elements. Recently, multi-camera solutions have been offered to provide a simulation of optical zoom, but these designs also suffer from a variety of deficiencies. Low distortion is difficult in a wide-angle lens, and particularly with low z-height. In addition, while creating a zoom without moving parts is desirable for a smartphone camera in many respects, zoom without moving parts (but with a large zoom ratio) is difficult to achieve using rotationally symmetric lenses. Use of rotationally symmetric lenses requires extra spacing between the lenses, which is undesirable when attempting to reconstruct, or stitch together, a wide angle image from multiple images taken at different points of view. Tilting of rotationally symmetric lenses allows an increased field of view, but adds a keystone distortion that is difficult to remove during processing.

As a result, there is a need for lens system designs that provide good image quality across a range of focal lengths extending from wide angle to zoom while still fitting within the z-height and volume available in a smartphone form factor.

### SUMMARY OF THE INVENTION

The present invention provides a plurality of optical designs using free form lenses which provide selectable focal lengths ranging from a wide angle field of view to a narrow field of view representative of a zoom lens while still fitting within the form factor required for modern smartphones. In an embodiment, the range of focal lengths operates to provide approximately a 10× zoom. Alternative embodiments provide other ranges of focal lengths and thus function as zoom lens of different optical powers while still complying with the form factor requirements of modern smartphones.

To overcome the challenges mentioned above, the present invention provides a trio of cameras, arranged so that the sensors are co-planar. In an embodiment, the cameras are arranged in a linear fashion, with the lens system of the center camera providing an axially symmetrical image on the sensor although not necessarily rotationally symmetrical, whereas the right and left cameras use freeform lenses to provide an off-axis image to their respective sensors. It will be understand by those skilled in the art that the description of left/center/right can also mean top/center/bottom or up/center/down, depending upon the orientation of the smartphone. To avoid unnecessary complication and possible confusion, only the left/center/right terminology will be used hereinafter.

In an embodiment, the images created by the left and right cameras and associated lens systems are slightly overlapped, and the center camera substantially overlaps both the left and right cameras. In such an embodiment, sensor of the center camera can be a substantially higher resolution than the sensors of the left and right cameras. By selecting left and right cameras, a wide angle image is achieved. By selecting just one of the left, right, or center cameras, with a reduced resolution of the center camera (e.g., binning), a “normal” image is achieved. By selecting a portion of the center camera, a zoom image is achieved.

In an alternative embodiment, the images created by the left and center cameras only slightly overlap, and the images created by the center and right cameras only slightly overlap. Depending upon the fields of view of each of the cameras, an ultrawide image is created when the images from all three cameras are stitched together. In an embodiment, the center camera is substantially higher resolution than the left and right cameras, but the center sensor can be binned to match the resolution of the left and right cameras. By selecting only the image from one of the cameras, the user can select different points of view and create a “normal” image. By selecting the center camera at full resolution, a high resolution image can be achieved. Finally, by selecting only a portion of the center camera's sensor, a zoom image is achieved.

To achieve the foregoing results, while still complying with the space and form factor limitations imposed by modern smartphones, at least the lens systems for the left and right cameras comprise at least one freeform element. In addition to providing wide angle and zoom images, stereoscopic images can be provided by separately capturing the left and right images and then processing those images into left and right stereo views.

In a still further alternative embodiment, a center camera having a lens system comprising at least one Alvarez pair of free form lenses is combined with left and right cameras and their associated off-axis lens systems to provide optical zoom as well as wide angle and normal images. The images from the left and right cameras overlap slightly, and the image from the higher resolution Alvarez center camera overlaps both left and right images. The Alvarez center lens system can be configured with positive optical power to yield optical zoom.

It is therefore one object of the present invention to provide optical zoom within the format factor limitations of a smartphone by providing a pair of cameras to create slightly overlapping images where the sensors of the pair are a first resolution, and further providing a third camera having a sensor of a higher resolution that creates a third, higher resolution image that substantially overlaps at least a central portion of the images created by the pair of cameras, such that the images from the pair of cameras provides a wide field of view, the image from a single camera provides a normal field of view, and the image from the centrally located camera provides either a high resolution image or a zoomed-in image of a portion of the sensor, all within the Z-height and other limitations of a smartphone.

It is a further object of the invention to provide an optical system that yields low distortion images at wide, normal and zoom fields of view.

These and other objects of the invention can be better appreciated from the following detailed description, taken in conjunction with the appended Figures.

### THE FIGURES

FIG. 1 illustrates a first embodiment of a multi-camera system for providing wide angle, normal and zoom images in accordance with the invention.

FIG. 2 illustrates a second embodiment of a multi-camera system for providing wide angle, normal and zoom images in accordance with the invention.

FIG. 3 illustrates an embodiment of the present invention which comprises a large sensor for the center camera together with a pair of off-axis cameras positioned on either side of the center camera, for 10× hybrid zoom and 3D depth sensing.

FIG. 4 illustrates an embodiment comprising 10× Alvarez optical zoom with overlapping off-axis left and right cameras for 3D stereo vision.

FIG. 5 illustrates an embodiment comprising 3× optical zoom with a 150 degree field of view and a larger central sensor.

FIG. 6 illustrates an embodiment comprising three cameras where the left and right images overlap the center image but not each other.

FIG. 7 illustrates an embodiment comprising three cameras where the left and right images can be used separately to yield a stereoscopic or 3D image.

FIG. 8 illustrates an embodiment comprising three cameras having the same resolution sensors where the separation between the left and right cameras is used to create 3D images and the center camera is used to improve or correct the 3D image created by the left and right cameras.

FIG. 9 illustrates an embodiment comprising three cameras having where the separation between the left and right cameras is used to create 3D images and the center camera, with a larger resolution, provides image correction and greater optical depth of field.

FIG. 10A illustrates an embodiment of the image processing system and process flow for the optical systems of the present invention.

FIG. 10B illustrates the software process flow appropriate for the image processing system of FIG. 10A.

FIGS. 11A-11D illustrate several possible arrangements of the three cameras on a smartphone in accordance with the invention.

FIGS. 12A-12B show ray path diagrams of the lens design for the edge [left and right] cameras and the center camera, respectively.

FIG. 13 illustrates the low distortion achieved for the left and right cameras off-axis cameras through use of at least one free form lens as described herein.

FIG. 14 illustrates several views of a freeform lens element for a right side camera together with a table of terms for an XY Polynomial description of the Z-sag of the freeform surfaces of the lens.

### DETAILED DESCRIPTION OF THE INVENTION

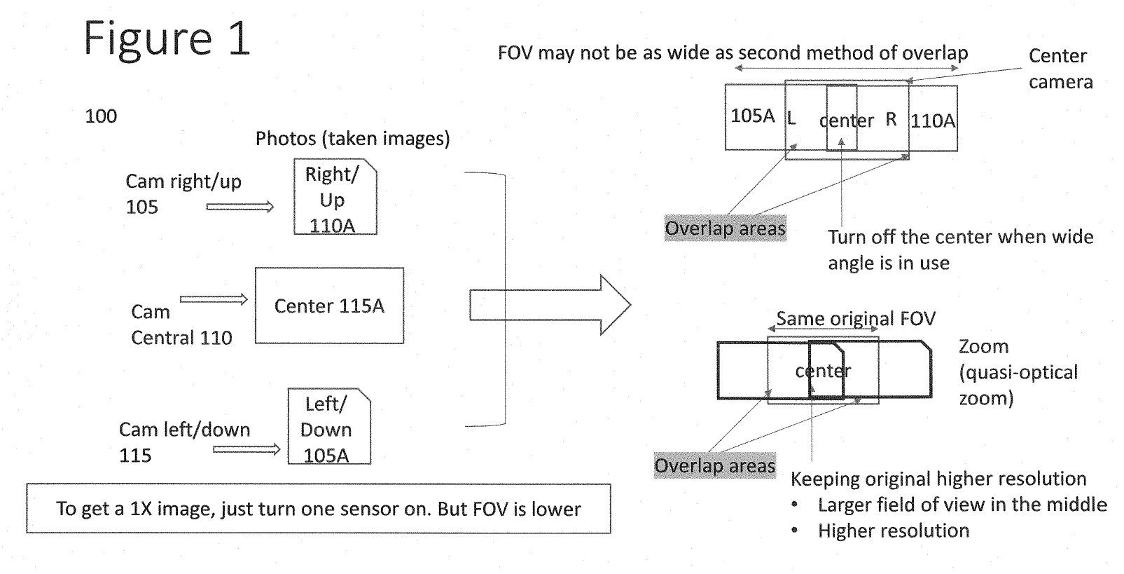

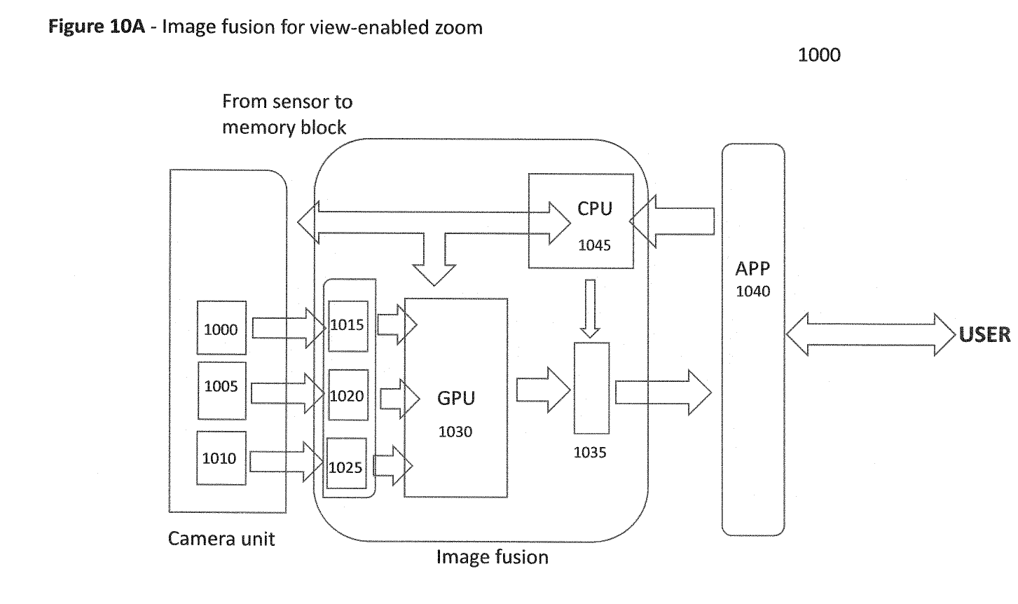

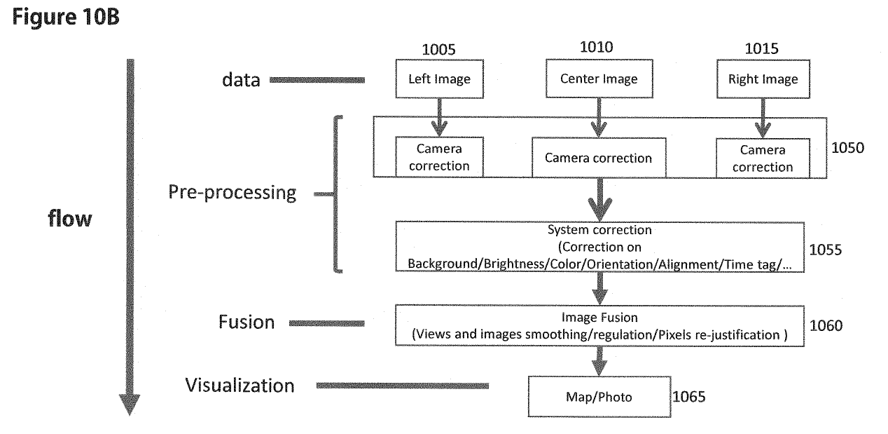

Referring first to FIG. 1, that figure illustrates a first embodiment of a multi-camera system 100 for providing wide angle, normal and zoom images in accordance with the invention. In particular, the embodiment of FIG. 1 comprises an off-axis left camera 105, an off-axis right camera 110, and a center camera 115. The images 105A and 110A, from the left and right cameras respectively, partially overlap one another at the center as shown, where the separation between the left and right cameras results from a balancing of the physical constraints of the lens elements, the desire to effect different perspectives characteristic of a 3D image, and the ability of the stitching software to assemble the left and right images into a single wide angle image. The image 115A from the center camera 115 overlaps the central portions of both the left and the right cameras, substantially as shown. As discussed in greater detail hereinafter, in at least some embodiments the sensor on the center camera is of a higher resolution than the left and right sensors, and the optics of the center camera may have more optical power that the lenses used on the side cameras. For the embodiment shown in FIG. 1, the images 105A and 110A from the left and right cameras can be stitched together by the image processing system of FIG. 10, discussed hereinafter, to form a wide angle image. A “normal” image can be captured by selecting only one of either the left camera or the right camera, or, in at least some embodiments, the center camera. Use of off-axis camera allows a significant reduction in the overlap of the two FOV's of the left and right cameras. This allows the overall FOV to be enlarged. That, in turn, permits the zoom ratio to be enlarged further, thus providing a major benefit to the consumer, along with numerous other benefits from the use of free form lens elements.

Selection of the camera(s) to be used can be accomplished by any convenient means, including a simple switch, or other controls as are well known in the art. In some embodiments, the center camera comprises a larger sensor, and may also have a lens system with positive optical power or a different field of view from the right and left cameras. In such cases, selection of the center camera alone can yield a higher resolution image, or a larger field of view, or an optically zoomed image, and so forth. The center image can also be used to improve or correct the image created by the left or right image, particularly but not solely when the left and right images are stitched to form a wide angle image.

The free form lenses required for the embodiments shown herein can be developed using a variety of mathematical approaches, for example either the use of XY polynomials or the use of Zernike polynomials. For the embodiment shown in FIG. 1, the following tables illustrate exemplary optical characteristics, from which those skilled in the art can appreciate the approach in a manner that allows different implementations without departing from the present invention. Thus, the table below shows characteristics of one embodiment of a center lens:

Central view
Lens
f/2.0, HFOV68.29,VFOV 60, visible

| radius of curvature | thickness | | |
|---|---|---|---|
| (1/mm) | (mm) | | materials |
| object | infinity | infinity | |
| Stop/L1 | 1.86451 | 0.478 | APL5014CL |
| | −5.76452 | 0.232 | |
| L2 | −6.83744 | 0.299 | OKP4HT |
| | 4.12556 | 0136 | |
| L3 | 48.94560 | 0.941 | E48R |
| | −1.98765 | 0.097 | |
| L4 | −1.47584 | 0.299 | EP7000 |
| | −10.33547 | 0.109 | |
| L5 | 5.41198 | 0.306 | OKP4HT |
| | −1.92213 | 0.771 | |
| filter | Infinity | 0.147 | BK7 |
| | | 0.140 | |
| image | | | |

The above example of a center lens system can be seen to comprise five elements L1 to L5, with an optional aperture in front of the first element L1. In an embodiment, the left and right cameras can have the characteristics shown in the below tables:

| | | Left Lens | |
|---|---|---|---|
| | radius of curvature | thickness | |
| | (1/mm) | (mm) | materials |
| object | Infinity | Infinity | |
| Stop/L1 | 2.03250 | 0.548 | APL5014CL |
| | −4.65517 | 0.170 | |
| L2 | −4.00749 | 0.284 | OKP4HT |
| | 8.56123 | 0.094 | |
| L3 | −23.23915 | 0.922 | E48R |
| | −1.88536 | 0.087 | |
| L4 | −1.50524 | 0.308 | EP7000 |
| | −7.11095 | 0.197 | |
| L5 | 4.79915 | 0.300 | OKP4HT |
| | −2.57178 | 0.792 | |
| filter | Infinity | 0.147 | BK7 |
| | Infinity | 0.140 | |
| image | | | |

| | | Right Lens | |
|---|---|---|---|
| | radius of curvature | thickness | |
| | (1/mm) | (mm) | materials |
| object | Infinity | Infinity | |
| Stop/L1 | 2.03250 | 0.548 | APL5014CL |
| | −4.65517 | 0.170 | |
| L2 | −4.00749 | 0.284 | OKP4HT |
| | 8.56123 | 0.094 | |
| L3 | −23.23915 | 0.922 | E48R |
| | −1.88536 | 0.087 | |
| L4 | −1.50524 | 0.308 | EP7000 |
| L5 | 4.79915 | 0.300 | OKP4HT |
| | −2.57178 | 0.792 | |
| filter | Infinity | 0.147 | BK7 |
| | Infinity | 0.140 | |
| image | | | |

Further, the freeform lenses, element L5 in the above, can have the XY polynomial coefficients shown below:

| XY | Right View Lens | | Left View Lens | |
|---|---|---|---|---|
| poly- | L5 | | L5 | |
| nomials | S9 | S10 | S9 | S10 |
| Co- | 0 | 0 | 0 | 0 |
| efficient | | | | |
| on | | | | |
| X1Y0 | | | | |
| Co- | −0.031394501 | −0.031998634 | −0.031394501 | −0.031998634 |
| efficient | | | | |
| on | | | | |
| X0Y1 | | | | |
| Co- | 0.54489998 | 0.99795168 | 0.54489998 | 0.99795168 |
| efficient | | | | |
| on | | | | |
| X2Y0 | | | | |
| Co- | 0 | 0 | 0 | 0 |
| efficient | | | | |
| on | | | | |
| X1Y1 | | | | |
| Co- | 0.52731321 | 0.96168082 | 0.52731321 | 0.96168082 |
| efficient | | | | |
| on | | | | |
| X0Y2 | | | | |
| Co- | 0 | 0 | 0 | 0 |
| efficient | | | | |
| on | | | | |
| X3Y0 | | | | |
| Co- | 0.00333121 | 0.014485685 | 0.0033312095 | 0.014485685 |
| efficient | | | | |
| on | | | | |
| X2Y1 | | | | |
| Co- | 0 | 0 | 0 | 0 |
| efficient | | | | |
| on | | | | |
| X1Y2 | | | | |
| Co- | 0.01230136 | 0.039159063 | 0.01230136 | 0.039159063 |
| efficient | | | | |
| on | | | | |
| X0Y3 | | | | |
| Co- | −0.33922956 | −0.5000752 | −0.33922956 | −0.5000752 |
| efficient | | | | |
| on | | | | |
| X4Y0 | | | | |
| Co- | 0 | 0 | 0 | 0 |
| efficient | | | | |
| on | | | | |
| X3Y1 | | | | |
| Co- | −0.65642894 | −0.9745911 | −0.65642894 | −0.9745911 |
| efficient | | | | |
| on | | | | |
| X2Y2 | | | | |
| Co- | 0 | 0 | 0 | 0 |
| efficient | | | | |
| on | | | | |
| X1Y3 | | | | |
| Co- | −0.32729094 | −0.48717843 | −0.32729094 | −0.48717843 |
| efficient | | | | |
| on | | | | |
| X0Y4 | | | | |
| Co- | 0 | 0 | 0 | 0 |
| efficient | | | | |
| on | | | | |
| X5Y0 | | | | |
| Co- | 0.008187585 | 0.014905099 | 0.0081875847 | 0.014905099 |
| efficient | | | | |
| on | | | | |
| X4Y1 | | | | |
| Co- | 0 | 0 | 0 | 0 |
| efficient | | | | |
| on | | | | |
| X3Y2 | | | | |
| Co- | −0.030083972 | −0.019664231 | −0.030083972 | −0.019664231 |
| efficient | | | | |
| on | | | | |
| X2Y3 | | | | |
| Co- | 0 | 0 | 0 | 0 |
| efficient | | | | |
| on | | | | |
| X1Y4 | | | | |
| Co- | −0.006150174 | −0.005890376 | −0.0061501742 | −0.0058903762 |
| efficient | | | | |
| on | | | | |
| X0Y5 | | | | |

Likewise, the aspheric coefficients for each of the surfaces of the lens elements for the center, left and right cameras can be appreciated from the below tables:

Left Lens

| | L1 | | L2 | | L3 | | L4 | |
|---|---|---|---|---|---|---|---|---|
| | Aspheric Coeffic. | | | | | | | |
| | S1 | S2 | S3 | S4 | S5 | S6 | S7 | S8 |
| c\hat{ }2 | −0.11243 | 0.02309 | 0.18711 | 0.08611 | −0.12482 | −0.33345 | 0.32175 | 0.24154 |
| c\hat{ }4 | −0.08292 | −0.31612 | −0.56353 | −0.33194 | −0.11701 | 0.11437 | 0.10274 | −0.13719 |
| c\hat{ }6 | −0.03703 | 0.03620 | −0.05915 | 0.07740 | 0.15157 | −0.09869 | −0.02005 | 0.09270 |
| c\hat{ }8 | −0.13000 | −0.03522 | −0.13538 | 0.01203 | −0.01056 | 0.02853 | 0.00760 | −0.03176 |
| c\hat{ }10 | −0.09267 | −0.18509 | 0.02292 | −0.01191 | 0.00583 | 0.01814 | −0.00179 | 0.00384 |
| c\hat{ }12 | 0.00000 | 0.00000 | 0.00000 | 0.00000 | 0.00000 | 0.00000 | 0.00000 | 0.00000 |
| c\hat{ }14 | 0.00000 | 0.00000 | 0.00000 | 0.00000 | 0.00000 | 0.00000 | 0.00000 | 0.00000 |
| c\hat{ }16 | 0.00000 | 0.00000 | 0.00000 | 0.00000 | 0.00000 | 0.00000 | 0.00000 | 0.00000 |

Right Lens

| | L1 | | L2 | | L3 | | L4 | |
|---|---|---|---|---|---|---|---|---|
| | Aspheric Coeffic. | | | | | | | |
| | S1 | S2 | S3 | S4 | S5 | S6 | S7 | S8 |
| c\hat{ }2 | −0.11243 | 0.02309 | 0.18711 | 0.08611 | −0.12482 | −0.33345 | 0.32175 | 0.24154 |
| c\hat{ }4 | −0.08292 | −0.31612 | −0.50353 | −0.33914 | −0.11707 | 0.11437 | 0.10274 | −0.13719 |
| c\hat{ }6 | −0.03703 | 0.03620 | −0.05915 | 0.07740 | 0.16157 | −0.09869 | −0.02005 | 0.09270 |
| c\hat{ }8 | −0.13000 | −0.03622 | −0.13538 | 0.01203 | −0.04056 | 0.02853 | 0.00760 | −0.03176 |
| c\hat{ }10 | −0.09267 | −0.18509 | 0.02292 | −0.01191 | 0.00583 | 0.01814 | −0.00179 | 0.00384 |
| c\hat{ }12 | 0.00000 | 0.00000 | 0.00000 | 0.00000 | 0.00000 | 0.00000 | 0.00000 | 0.00000 |
| c\hat{ }14 | 0.00000 | 0.00000 | 0.00000 | 0.00000 | 0.00000 | 0.00000 | 0.00000 | 0.00000 |
| c\hat{ }16 | 0.00000 | 0.00000 | 0.00000 | 0.00000 | 0.00000 | 0.00000 | 0.00000 | 0.00000 |

Center Lens

| | L1 | | L2 | | L3 | | L4 | |
|---|---|---|---|---|---|---|---|---|
| | Aspheric Coeffic. | | | | | | | |
| | S1 | S2 | S3 | S4 | S5 | S6 | S7 | S8 |
| c\hat{ }2 | −0.10926 | 0.03059 | 0.18558 | 0.10472 | −0.11052 | −0.35756 | 0.36804 | 0.30215 |
| c\hat{ }4 | −0.09811 | −0.28332. | −0.59408 | −0.39547 | −0.11656 | 0.10764 | 0.12436 | −0.12801 |
| c\hat{ }6 | −0.02622 | −0.06429 | −0.07854 | 0.09460 | 0.16054 | −0.09839 | −0.02682 | 0.09487 |
| c\hat{ }8 | −0.09926 | 0.12720 | −0.21910 | 0.01724 | −0.04278 | 0.03447 | 0.00868 | −0.03456 |
| c\hat{ }10 | −0.28068 | −0.39632 | 0.05563 | −0.01925 | 0.00769 | 0.02163 | −0.00305 | 0.00427 |
| c\hat{ }12 | 0.00000 | 0.00000 | 0.00000 | 0.00000 | 0.00000 | 0.00000 | 0.00000 | 0.00000 |
| c\hat{ }14 | 0.00000 | 0.00000 | 0.00000 | 0.00000 | 0.00000 | 0.00000 | 0.00000 | 0.00000 |
| c\hat{ }16 | 0.00000 | 0.00000 | 0.00000 | 0.00000 | 0.00000 | 0.00000 | 0.00000 | 0.00000 |

Those skilled in the art will recognize that the Extended XY Polynomial coefficients are for use in the following equation:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y ) .$$

where z, x, y are cartesian coordinates of the surface, c is surface curvature, r is the surface radial coordinate, k is the conical constant, Aᵢ are polynomial coefficients, Σ(x,y) are polynomials, as discussed in great detail in U.S. Patent Application Ser. No. 62/748,961 filed on 22 Oct. 2018 and incorporated herein by reference.

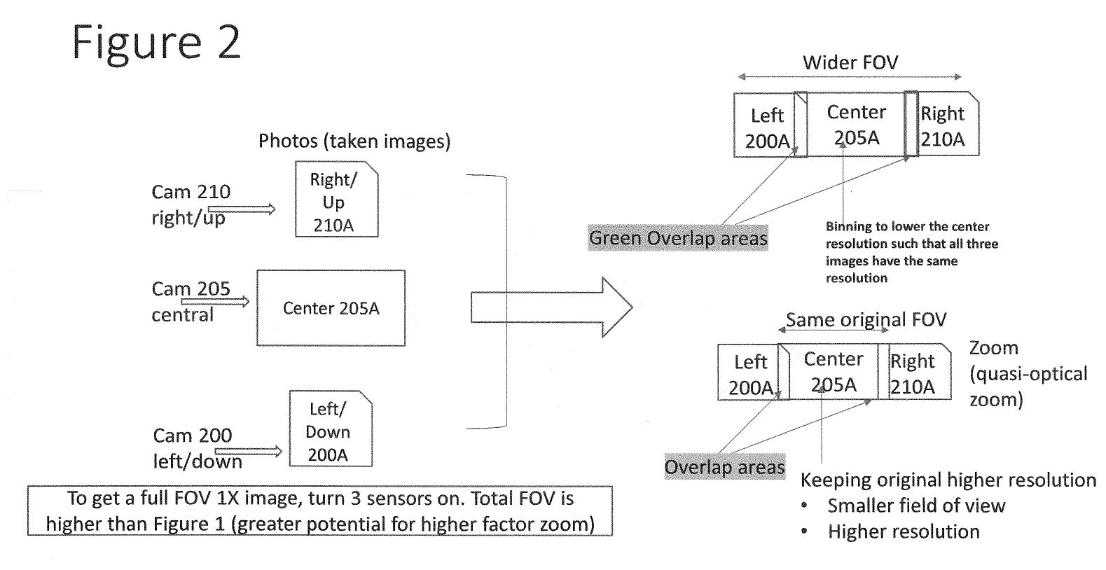

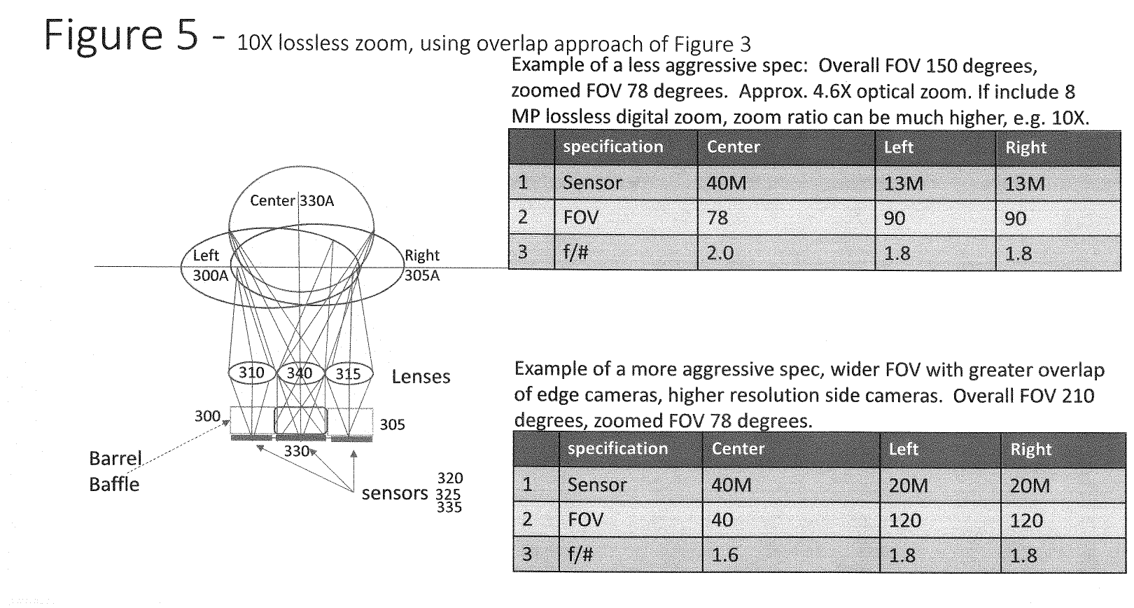

Referring next to FIG. 2, an alternative embodiment of a three-camera optical system is illustrated. In the embodiment of FIG. 2, left camera 200 is positioned relative to center camera 205 and right camera 210 such that the image 200A from camera 200 overlaps a portion at the left of the image 205A from center camera 205 and the image 210A from right camera 210 overlaps a right portion of the image 205A from center camera 205, but the images 200A and 210A from cameras 200 and 210 do not overlap. Since nearly the full field of view from all three cameras can be used to stitch a wide angle view, this arrangement permits the capture of images having a wider overall field of view that the embodiment of FIG. 1. This feature will be discussed in greater detail hereinafter. The wider separation of the left and right images also permits greater 3D depth. Typically, although not necessarily, the left and right camera sensors (sensors are shown in, for example, FIG. 5, among others) are the same aspect ratio and resolution. In some instances the center camera will have the same sensor as left and right cameras, but in other embodiments the center camera may be significantly higher resolution, such that binning of the pixels of the center camera may be appropriate so that the resolution of the center camera is matched to the resolution of the side cameras when an image is stitched from all three cameras. If the center sensor is significantly higher resolution than the side sensors, a zoomed-in image can be achieved either by providing positive optical power/narrower field of view for the center lens module, or using digital zoom and taking advantage of the extra pixels available from the higher resolution sensor, or a hybrid combination of both optical zoom and digital zoom. In some instances the field of view [sometimes “FOV” hereafter] of the center camera will be larger than the field of view for the side cameras.

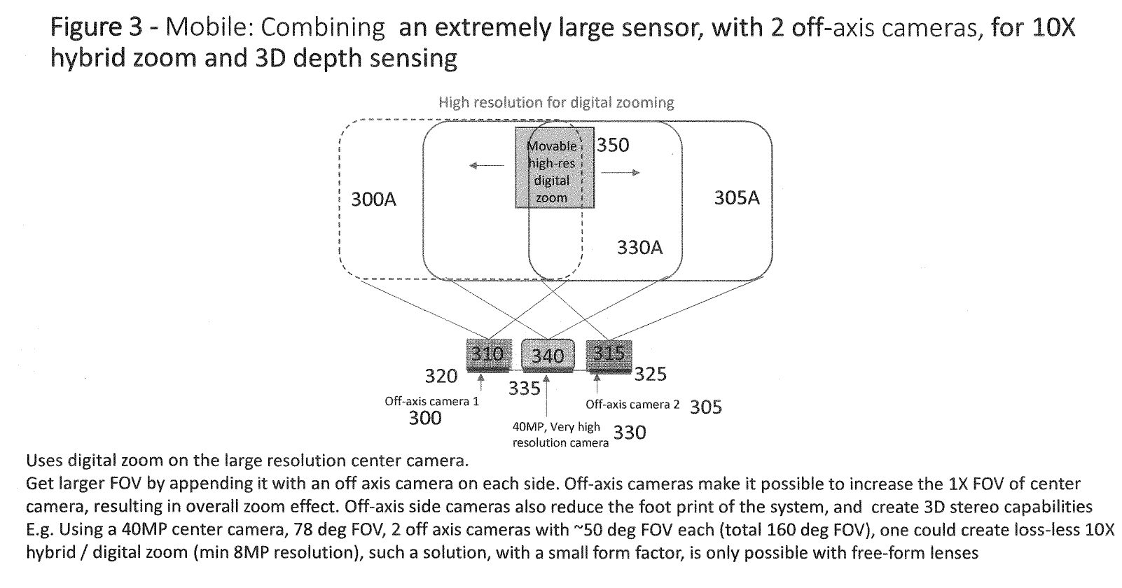

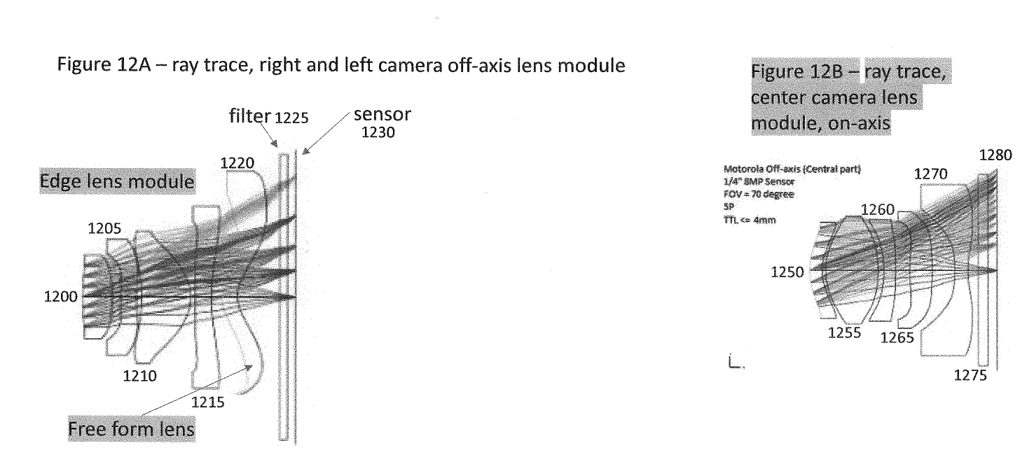

Turning next to FIG. 3, use of the embodiment of FIG. 1 to yield wide angle, normal, and zoomed images can be better appreciated. The left camera 300 and right camera 305 are, for the embodiment shown, off-axis cameras which means that the lens modules 310 and 315 for those side cameras essentially shift laterally the images 300A and 305A, respectively, projected onto the associated sensors 320 and 325. An exemplary ray path for the off-axis lens module can be seen in FIG. 12A, discussed in greater detail hereinafter. It will be appreciated that the left and right lens modules are arranged as a stereo pair, with a right portion of image 300A overlapping the left portion of image 305A. The center camera 330 and associated sensor 335 create center image 330A, which overlaps substantially equally images 300A and 305A. The off-axis lens modules allow the right and left cameras to be positioned closer to center camera 330. The image created by the center camera's lens module 340 is, in at least some embodiments, axially disposed but can be implemented with at least one free form lens to minimize Z-height and distortion, for example a double plane symmetry lens to match the image shape to the sensor shape.

In one embodiment of the configuration shown in FIG. 3, the center sensor 335 can be approximately 40 MP resolution, while the left and right sensors 320 and 325 can be much lower, for example 8 MP resolution. Other embodiments may call higher resolution on the left and right sensors, for example 20 MP resolution. For the example of a 40 MP center sensor and 8 MP side sensors, the center lens module may have a FOV of 78 degrees while the left and right lens modules each has a 90 degree FOV. With overlap, the left and right cameras can achieve a wide angle image of approximately 160 degrees. Using only one of the left or right cameras provides an image with a “normal” field of view. But by using only the center camera, the user has a choice of a high resolution image 330A, or can select a portion of the image 330A, such as the box shown at 350. Because of the high resolution of the center sensor 335, digital zooming still yields an image equal in resolution to that provided by the left and right cameras. The result is that the user perceives the operation as optical zoom. The selection of the zoomed in portion can be done in any convenient manner, for example via touchscreen. As previously noted, the left and right cameras can each be selected to yield stereoscopic images, or images that provide improved 3D imaging.

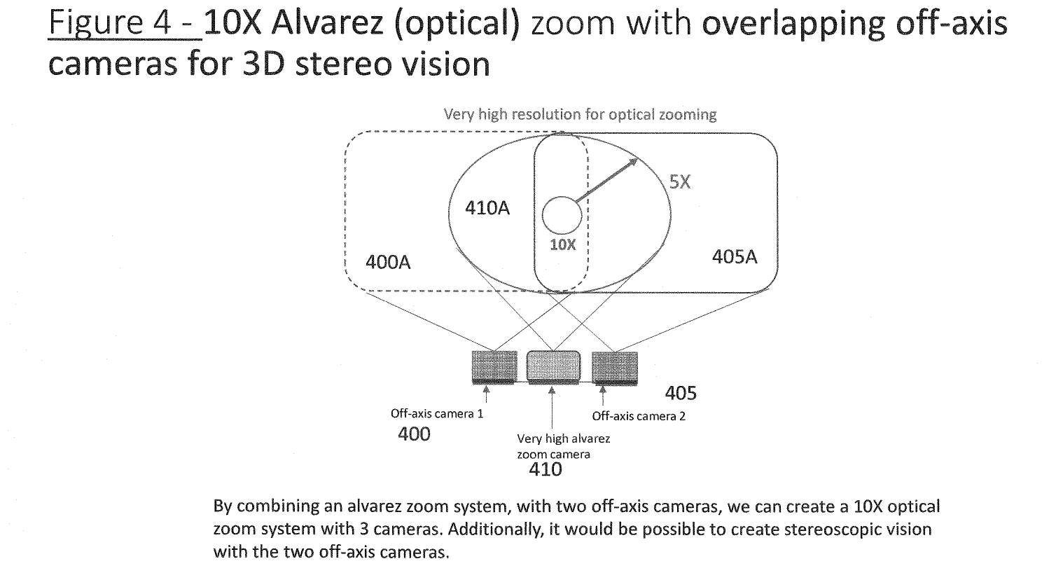

Referring next to FIG. 4, an alternative to the embodiment of FIG. 3 is illustrated in which left and right off-axis cameras 400 and 405 create images 400A and 405A, respectively, which overlap one another at the similar to FIG. 3. Center camera 410 captures image 410A and comprises a lens module having an Alvarez lens pair. The overall FOV as comprised of the left and right images can be 140 deg, 160 degrees, or more. An Alvarez lens pair, which provides two separate but selectable focal lengths, can have FOV 14 and FOV 28 (for the case of 140 degree total FOV) when zooming, the corresponding zoom ratios are 140/14=10× and 140/28=5×. In case of an overall FOV of 160 degrees, then the Alvarez lens can be designed to have 16 degrees and 32 degrees FOV's, which yields a 10× zoom ratio as indicated at the center of the field, and a 5× zoom ratio inside the outer circle, also as indicated in FIG. 4. The two off-axis cameras can also create stereoscopic images, as discussed above.

FIG. 5 illustrates in further detail a three-camera system similar to FIG. 3, above, and in which like elements are shown with like reference numerals. Two approaches are shown by the tables of FIG. 5, the upper table showing a lower zoom ratio and the lower table showing a higher zoom ratio. Thus, for the top table, the center sensor 335 is, in the illustrated embodiment, 40 MP while the right and left sensors are 13 MP. The left and right images overlap at the center of the overall FOV, and the center camera overlaps the right and left images substantially equally. The center camera has a field of view of 78 degrees, whereas the off-axis right and left cameras each have a field of view of 90 degrees. Further, the f-number for the center camera is 2.0, while for the left and right cameras the f-number is 1.8. The off-axis lens module and the center lens module all use free form lenses, as discussed above in connection with FIG. 1. The overall FOV resulting from the left and right images can be approximately 150 degrees, taking into account the loss of FOV due to the overlap. Using the different FOV's of the center camera versus the right and left, the zoom ratio can be calculated as follows: Rzoom=tangent(full FOV/2)/tangent(zoomed FOV/2)=tan(75)/tan(39)=˜4.6.

The embodiment shown in the lower table uses a center sensor of 40 MP with left and right sensors of 20 MP each. The center lens system again has a 40 degree FOV, while the side cameras each have a FOV of 120 degrees, for a total FOV between then (accounting for overlap) of approximately 210 degrees, resulting in a higher zoom ratio.

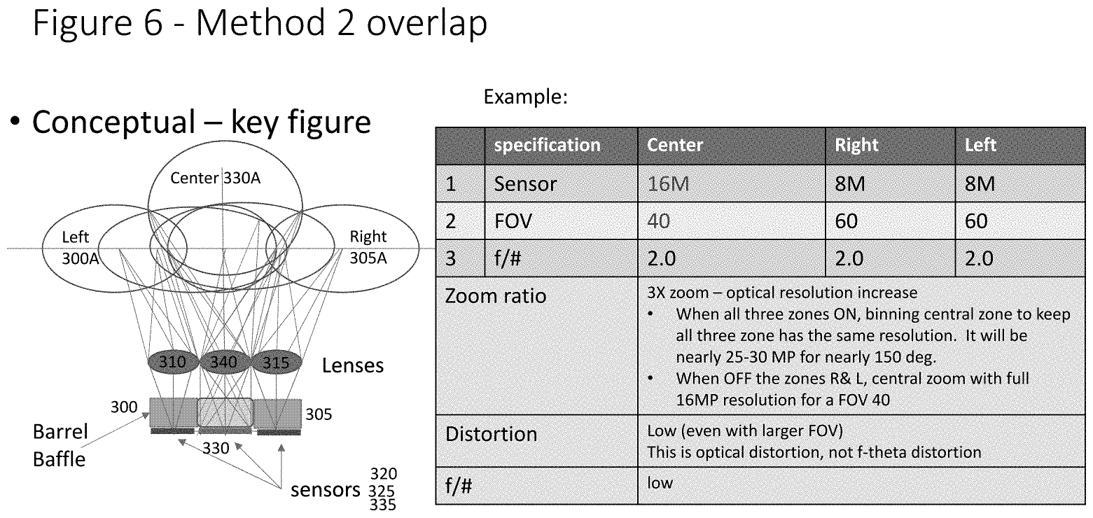

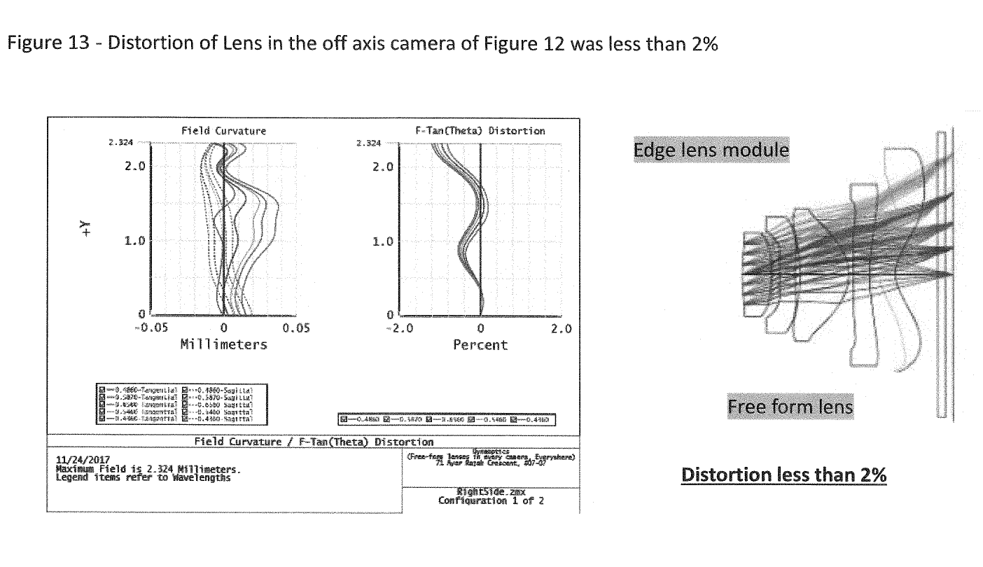

Referring next to FIG. 6, an embodiment using the overlap approach shown generally in FIG. 2 can be appreciated in greater detail. It will be appreciated that the off-axis characteristics can described using the same exemplary approach set forth above in connection with FIG. 1, Thus, as shown in the table of FIG. 6, the center sensor is 16 MP while the right and left sensors are 8 MP each, the center camera FOV is 40 degrees while the right and left camera FOV's are 60 degrees each. Each of the camera's lens system has an f-number of 2.0 in the example shown. When all three cameras are on, the image sensor of the center camera is binned to match the lower resolution of the left and right cameras. Taking all three cameras together, the overall FOV approaches 150 degrees, and the overall resolution approaches 25 MP. However, by using just the center camera, the captured image has an FOV of only 40 degrees, with full resolution at 16 MP. The result is approximately a 3× increase in optical resolution, or zoom. In addition, using free form lenses as described above provides the zoom benefit while maintaining low optical distortion as discussed in connection with FIG. 13, below.

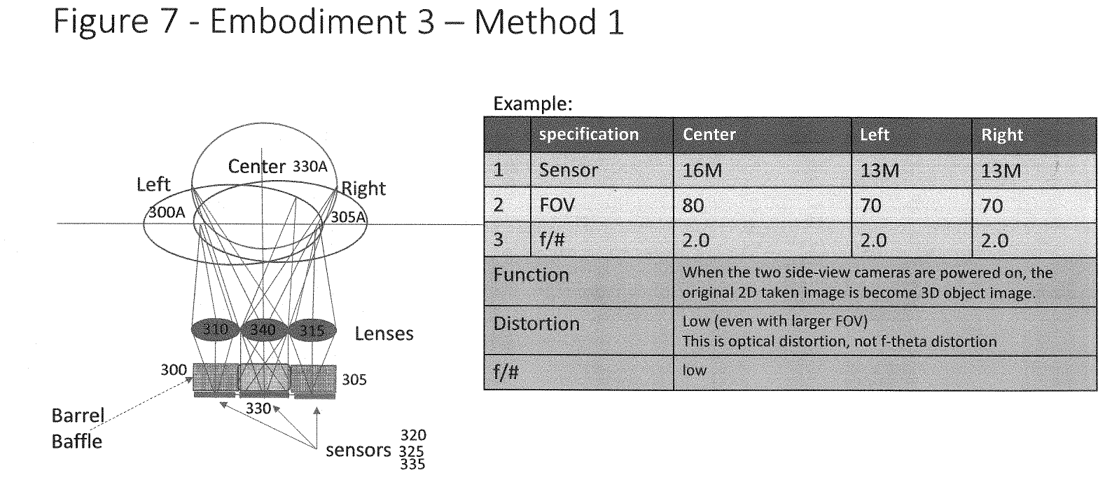

FIG. 7 illustrates a still further alternative embodiment which uses the two side cameras to yield separate images that form a 3D object image. As before, like numerals indicate like elements. In an embodiment, the center sensor is 16 MP while the side sensors are each 13 MP, the center FOV is 80 degrees and the side FOV's are each 70 degrees. All f-numbers are 2.0. By using the images from the left and right cameras, which each capture a different perspective because of the inter-camera spacing, a 3D image can be constructed. The center image can be used to improve upon and correct any deficiencies in the left and right image, such as distortion.

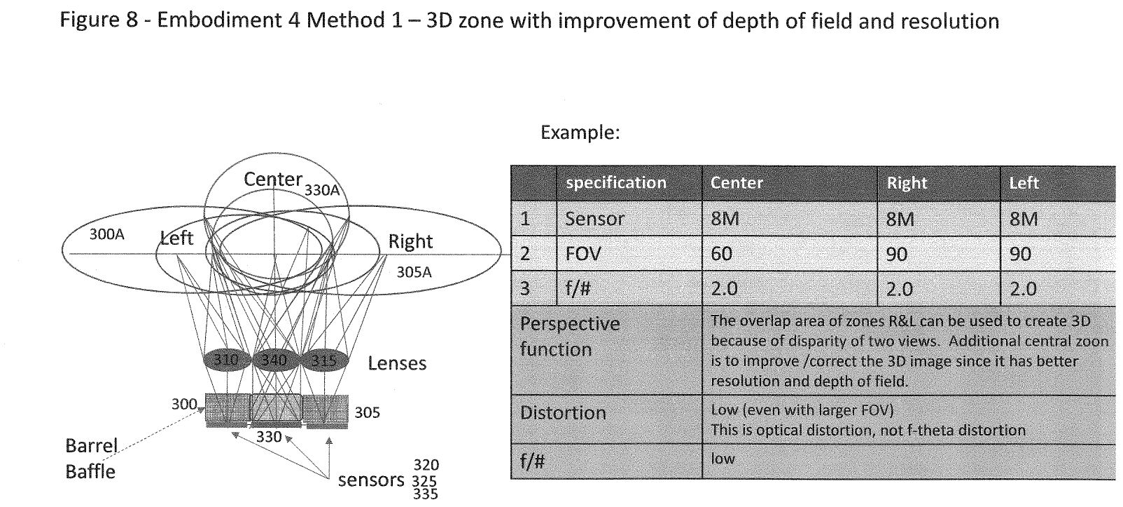

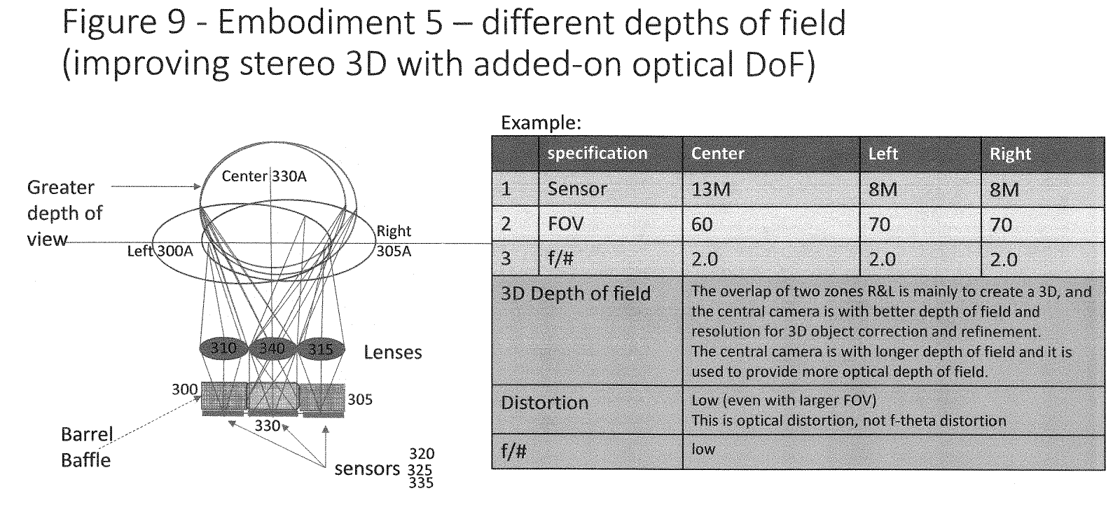

Referring next to FIGS. 8 and 9, further alternative embodiments for providing both zoom and stereo 3D images can be appreciated, where the center camera, at higher resolution, provides greater depth of field and can be combined with the stereo images from the left and right cameras to improve image quality in the form of increased optical depth of field. As before, like elements are shown with like reference numerals.

Referring next to FIG. 10A, the image processing aspect of the present invention can be better appreciated. The incoming images, 1000, 1005 and 1010, are provided by the camera unit to data buffers 1015, 1020 and 1025, where the images are processed in GPU 1030. The processed images are then stored in data store block 1035. From there, they can be viewed on the consumer device via a conventional application, or app, 1040. The user can make selections or manipulate the image via the app and those instructions are sent to the CPU 1045 of the mobile device. The CPU determines what response is needed to the instructions from the app, and communicates with the camera unit, CPU and data store block.

The GPU can be any of a variety of devices, such as those available from Intel, Nvidia, and others. The software operating on the GPU will typically depend on the specific implementation and which GPU is selected. FIG. 10B illustrates can be developed in any of a variety of languages, such as C++ or C, Python, MatLab, and so on by those of ordinary skill given the teachings herein. If an Intel-based GPU is used, the software will most likely be written for Intel's OpenCV. Referring to FIG. 10B, each of the images 1005, 1010 and 1015 are initially pre-processed at step 1050 by the GPU for camera correction, where the amount and type of correction necessary is specific to the mating of the lens system to the sensor, among other things, and typically involves dewarping, color correction. Once camera correction is complete, the process advances to step 1055 for system correction. System correction comprises adjustments for background, brightness, color, orientation, alignment, time stamping or tagging, and so on. Finally, after the corrections have been made, the process advances to step 1060, for image fusion. Depending upon the options chosen by the user, the image fusion can comprise stitching two or more of the images together, or creating a stereoscopic image, or correcting or enhancing an image through the use of the greater resolution of the center camera, but the actual choices will typically be specific to the implementation and that system's particular purpose. Finally, once the image fusion step is complete, the pixels are mapped to a display and the photo can be viewed by the user, as shown at 1065. As noted by FIG. 10A, the user can then request further manipulation of the image, can select one or more other images, select a different option for that image set, and so on.

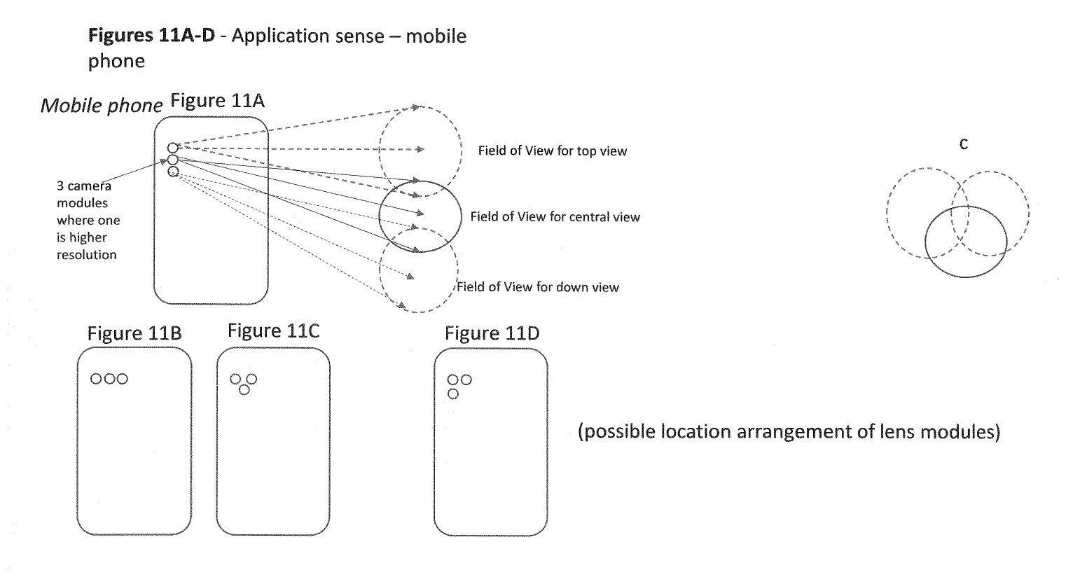

Referring next to FIGS. 11A-D, various alternative layouts for placement of the three cameras of the present invention within the form factor of the mobile device's case can be better appreciated. The cameras can be arranged linearly, as shown in FIGS. 11A and 11B, either vertically or horizontally. However, because of the off-axis capability of the free form lenses of the present invention, it is also possible to arrange the cameras in a triangular shape as shown in FIGS. 11C and 11D.

Referring next to FIGS. 12A and 12B, the ray paths for exemplary edge cameras and a center camera, respectively, can be better appreciated. FIG. 12A shows an off-axis lens module comprising five optical elements 1200, 1205, 1210, 1215 and 1220, a filter 1225, and a sensor 1230. An optional aperture can be placed in any convenient location, such as before the first element 1200. Exemplary details of the lens elements can be seen in the tables discussed above in connection with FIG. 1, including the materials for each lens element. In an off-axis camera such as shown in FIG. 12A, with at least one free form lens, in some embodiments the optical axis is tilted so that final distortion is minor. FIG. 12B, the ray path for the center camera, again shows a five element lens system comprising elements 1250, 1255, 1260, 1265 and 1270. Filter 1275 and sensor 1280 complete the stack. It will be appreciated that, since the center camera is axially symmetric, only the upper half ray path is shown. One or more elements may be freeform such as the double symmetry lenses described in U.S. Patent Application Ser. No. 62/748,961 entitled Lens Systems Using Free Form Elements to Match Object Space and Image Space, and Methods Therefor, filed on 22 Oct. 2018 and incorporated herein by reference.

Turning next to FIG. 13, the field curvature and the distortion of an edge lens module in accordance with the present invention can be better appreciated from the graphs shown in the figure. As those skilled in the art will recognize, distortion is less that 2%.

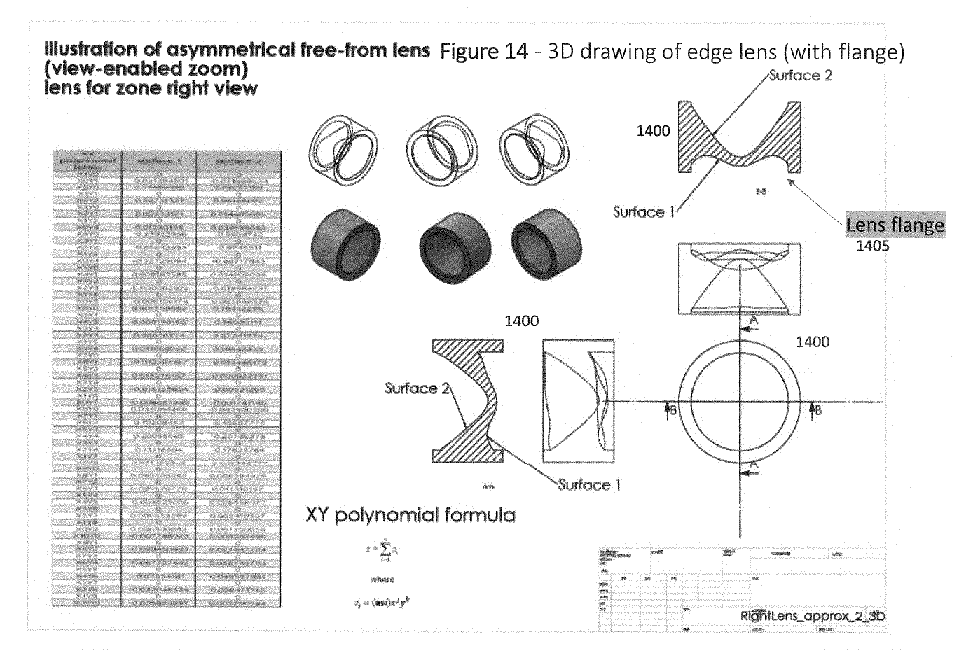

Next, with reference to FIG. 14, an embodiment of a free form lens element in accordance with the present invention can be better appreciated. The XY Polynomial terms for the Z-sag of the free form lens element 1400 is shown in the table at the left, and define the optically active area shown in the various views of the element 1400. The lens flange 1405 is used for mounting and not otherwise optically active.

While various embodiments of the invention have been disclosed in detail, it will be appreciated that the features of the exemplary embodiments discussed herein are not to be limiting, and that numerous alternatives and equivalents exist which do not depart from the scope of the invention. As such, the present invention is to be limited only by the appended claims.

We claim:

1. A lens array for a multi-camera optical system comprising
a center lens system configured to provide a center image of an object space onto a center sensor associated with the center lens system,
a left lens system configured to provide a left image of an object space onto a left sensor associated with the left lens system, the left lens system comprising at least one free form lens such that the left image is an off-axis image, and
a right lens system configured to provide a right image of an object space onto a right sensor associated with the right lens system, the right lens system comprising at least one free form lens such that the right image is an off-axis image.

2. A multi-camera optical system comprising
a center camera comprising a center lens system and a center sensor configured to provide a center image of an object space,
a left camera comprising a left lens system and a left sensor configured to provide a left image of an object space, the left lens system comprising at least one free form lens such that the left image is an off-axis image, and
a right camera comprising a right lens system and a right sensor configured to provide a right image of an object space, the right lens system comprising at least one free form lens such that the right image is an off-axis image.
wherein a selection of different combinations of left, center and right images provides a choice of wide angle, normal, and zoom images of the object space.

3. The lens array of claim 1 wherein at least one surface of at least one of the free form lenses is double symmetry.

4. The lens array of claim 1 wherein the Z-sag of at least one surface of at least one of the free form lenses is defined by an Extended XY polynomial.

5. The lens array of claim 1 wherein the Z-sag of at least one surface of at least one of the free form lenses is defined by a Zernike polynomial.

6. The multi-camera optical system of claim 2 wherein the Z-sag of at least one surface of at least one of the free form lenses is defined by one of a group comprising double symmetry, Extended XY Polynomial, and Zernike polynomial.

7. The lens array of claim 1 wherein the center lens system comprises at least one Alvarez pair.

8. The multi-camera optical system of claim 2 wherein the center lens system comprises at least one Alvarez pair.

9. The lens array of claim 1 wherein the center lens system provides optical zoom.

10. The multi-camera optical system of claim 2 wherein the center lens system provides optical zoom.
